(19) United States
(12) Patent Application Publication
(10) Pub. No.: US 2004/0004412 A1
(43) Pub. Date: Jan. 8, 2004

(54) Self energetic motors and generators

(76) Inventor: Shilumon Joseph Kochuvettukattil, Kottayam (IN)

Correspondence Address: SHILUMON JOSEPH, 7609 OAKLANE ROAD, CHELTENHAM, PA, 19012, US

(21) Appl. No.: 10/189,743

(22) Filed: Jul. 8, 2002

(51) Int. Cl. H02K 21/00

(52) U.S. Cl. 310/273

(57) ABSTRACT

The basic machine is a union of a D.C. generator and D.C. motor. One end of the shaft of the motor and the armuture of the generator is connected with insulated materials. Remaining parts of joint between the two machines are separated with an insulated material. For the starting of the machine a chargable battery is needed. As the shaft of the motor and armuture of the generator are connected, both are rotating simultaneously. Now the current from the generator is connecting to the motor through an Automatic voltage regulator. Now the connection from the battery is automaicaly switched off, and working with the current from the generator. Now this machine is a self power machine.

The other end of the motor shaft can be connect with an Alternator to rotate its field system. The current from the D.C. generator is to be use as the exciter.

Now this machine is a self energetic Alternator.

So the structure of the basic D.C. machine is summerized as follows. Battery-Motor-Generator-Voltage regulator-Motor.

If the other end of the motor shaft is connected with an Alternator, the machine is become a self energetic Alternator.

### CROSS REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

The field of invention was the workshope in my home in India. Since the D.C generators and Motors have the same parts, I found that it can work together.

### BRIEF SUMMARY OF INVENTION

The structure of the basic D.C. machine is summerized as follows. Battery-Motor-Generator-Voltage regulator-Motor.

If the other end of the motor shaft is connected with an Alternator, the machine is become a self energetic Alternator.

### SPECIFICATION

Self Energetic Motors and Generators

I here introdusing the self energtic electrical motors and generators. Or, the generators and Motors which is working without any external source of power.

As we know, generators are working by mechanical force and motors are by electrical Force.

Generators reqired mechanical force, that can be given by the motor. Motors required electrical force and that can given by the generator. So if this two machines are connected Together, it should a self powered machine. But the connection between the two machines should be insulated. Since, both machines have similar parts, both machines should be separated with a sheet of insulated material.

The basic machine is a union of a D.C. generator and a D.C. motor. There is applied e.m.f in the motor and induced e.m.f in the generator. Both machines have to do different jobs simultaneously. So it should be work together only if the machines are separated and connected by the insulated materials.

Structure of the basic machine is as follows.

The basic machine is a union of a D.C. generator and D.C. motor. One end of the shaft of the motor and the armuture of the generator is connected with insulated materials. Remaining parts of joint between the two machines are separated with an insulated material. For the starting of the machine a chargable battery is needed. As the shaft of the motor and armuture of the generator are connected, both are rotating simultaneously. Now the current from the generator is connecting to the motor through an Automatic voltage regulator. Now the connection from the battery is automaicaly switched off, and working with the current from the generator. Now this machine is a self power machine.

The other end of the motor shaft can be connect with an Alternator to rotate its field system. The current from the D.C. generator is to be use as the exciter.

Now this machine is a self energetic Alternator.

So the structure of the basic D.C. machine is summerized as follows. Battery-Motor-Generator-Voltage regulator-Motor.

If the other end of the motor shaft is connected with an Alternator, the machine is become a self energetic Alternator.

What I claim as my invention is that,

1. As we know, generators are working by mechanical force and motors are by electrical force:
Generators reqired mechanical force, that can be given by the motor. Motors required electrical force and that can given by the generator. So if this two machines are connected Together, it should a self powered machine. But the connection between the two machines should be insulated. Since, both machines have similar parts, both machines should be separated with a sheet of insulated material.
The basic machine is a union of a D.C. generator and a D.C. motor. There is applied e.m.f in the motor and induced e.m.f in the generator. Both machines have to do different jobs simultaneously. So it should be work together only if the machines are separated and connected by the insulated materials.
